(19) United States
(12) Patent Application Publication
(10) Pub. No.: US 2014/0195288 A1
(43) Pub. Date: Jul. 10, 2014

(54) SYSTEMS AND METHODS FOR LOCALLY OUTSOURCING WORK

(71) Applicant: Ranvir Singh, Fremont, CA (US)

(72) Inventor: Ranvir Singh, Fremont, CA (US)

(21) Appl. No.: 14/157,019

(22) Filed: Jan. 16, 2014

Related U.S. Application Data
(63) Continuation-in-part of application No. 12/956,937, filed on Nov. 30, 2010, now abandoned.

(51) Int. Cl. G06Q 10/06

(52) U.S. Cl. CPC G06Q 10/063114
USPC 705/7.15

(57) ABSTRACT

Systems and methods are disclosed that provides local outsourcing by guaranteeing that a consultant will be available at a premise of a customer within a first predetermined period on request; guaranteeing that the customer can visit the consultant's premise within a second predetermined period on request; and guaranteeing that one or more required resources and the consultant will be available at the customer's premise within a third predetermined period on request.

This application is a continuation in part of U.S. application Ser. No. 12/956,937 filed Nov. 30, 2010, the content of which is incorporated by reference.

The present application relates to locally outsourced workload handling.

There are two types of companies as it relates to software. One that makes the software and the others use the software made by the first one. The ones that make the software are constantly looking at reducing the cost of software development and support for their software. The ones that use the software are always looking at reducing the cost of supporting and enhancing their installed software. Both types of companies try to reduce their costs by outsourcing their operations to companies with low cost sources of labor. The basic premise behind such outsourcing decisions is that low labor cost means low cost of supporting software and hence savings for their companies.

While such an approach makes sense when an entire department with product engineering, marketing and development is moved offshore, such an approach does not produce desired results when the offshore outsourced resources provide service to clients in US that require frequent interactions with the user. Delays in issue resolution and frustration cause by overnight interactions with people on a different continent result in productivity loss and reduced employee morale.

US Application Serial No. 20050222884 shows a resource planning system for receiving a first scheduling request for a resource's time. This first scheduling request may include a date range and the estimated amount of time needed from the resource, but does not necessarily include concrete date and time facts. This first scheduling request may be refined by a second scheduling request, which specifies concrete date and time facts to schedule a portion of the resource's time that was originally requested by the first scheduling request.

As further noted in US Application Serial No. 20080086354, a software development team may be formed with one or more representatives from each of the many functional areas involved in the software development process. For example, a development team may include representatives from product management, pre-sales and sales, research and design, product development, quality assurance, and documentation. Furthermore, the functions of the various groups may interrelate, such that the groups may often consult with each other during the software development process to ensure delivery of a cohesive, working product. For example, the quality assurance group may work closely with at least the product development group to ensure a bug free and functionally complete product. The software development process may require input from many different functional groups. The resulting interdependencies have the potential to considerably increase the complexity of the process. Also, some of the tasks may be more strongly linked to other tasks as opposed to others. For example, Sales and Pre-sales are relatively stand-alone tasks as opposed to Quality Assurance, which is tightly integrated to Product Development. As another observation, some core tasks, such as Product Development, for example, drive the product. Finally, some tasks may be performed more efficiently the closer the task is located to the customer base, while other tasks may be performed remotely without affecting the quality of the product or the efficiency of the development process. Once the specifications are written, for example, developers working practically anywhere in the world may write the code. Functions like sales, however, may operate more efficiently the closer the sales group is located to the customer base.

### SUMMARY

The system provides contractors working from a different location within a predetermined physical proximity such as within a 40 mile radius. The consultants are close enough to be considered “on-site”, yet there is no co-employment issue as per State Law. The benefits of outsourcing can be achieved without the usual issues associated with outsourcing. The system provides a cost effective MADE IN USA outsourcing solution.

In one embodiment, an offsite model is supported where resources work from a provider's office. On-boarding is done as if resources will be working as onsite to facilitate logistics issues. In another embodiment with both offsite and onsite models, resources work from partially from the provider's office and partially from a client office. On-boarding is done as if resources will be working as onsite to facilitate logistics issues. In most cases consultants will work remote for most part and will visit client site for work or for meetings at least once each week.

Advantages of the preferred embodiment may include one or more of the following. The system supports local outsourcing. The contractors work in the same time zone with the same work culture. The contractors can be checked for compliance such as Sarbane Oxley (SOX) compliance. On-site orientation and process training can be provided to the contractors. Face to face collaboration can be done. The system provides competitive pricing. Due to local presence, customers face no significant travel costs. The system supports customers with compatible Business and After hours schedules. A flexible staffing size is supported that can rapidly ramp up during peak periods and ramp down when they don't need increased number of resources. The system provides quick augmentation for urgent assignments. Work-Life balance can be achieved for the customer's full-time staff. For example, meeting and conference calls are made during business hours rather than at night. On-site Meetings and collaboration sessions can be easily scheduled. No special high availability redundant infrastructure setups are required to support customers, thereby allowing low cost of service delivery and allowing the company to compete with offshore outsourcing solutions. Clients don't need to create special positions for managing remote resources assigned to client projects. The system provides independent staff management where managers can have contracted staff as a group reporting dotted line into them. Onsite training and SAP orientations can be achieved.

### BRIEF DESCRIPTION OF THE DRAWINGS

FIG. 1A shows an exemplary planning system supporting outsourcing work that enables a local appearance, while FIG. 1B shows an exemplary process for providing off-site and on-site outsourcing that together provides effective in-my-city work outsourcing.

FIG. 2A shows an exemplary off-site model

FIG. 2B shows an exemplary on-site and off-site model.

FIGS. 3A-3C show exemplary local outsourcing systems.

FIG. 4 illustrates an exemplary client/server system used in implementing one or more embodiments of the invention.

FIG. 5 shows an exemplary computer system used in implementing an embodiment of the present invention.

### DESCRIPTION

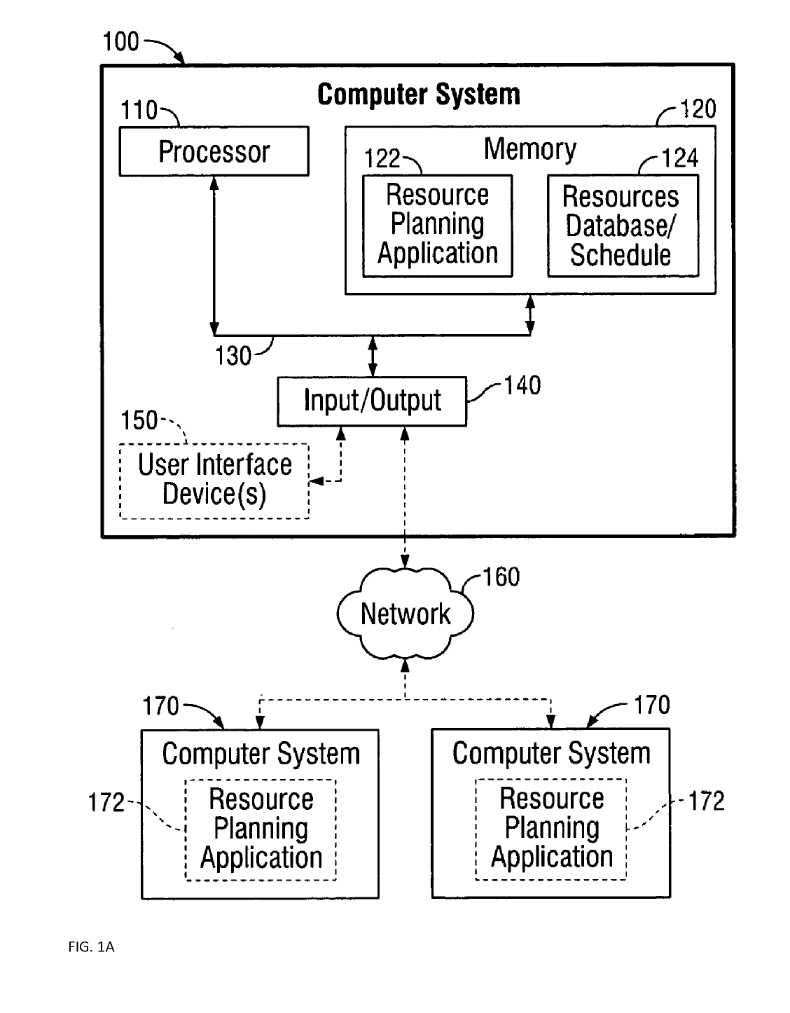

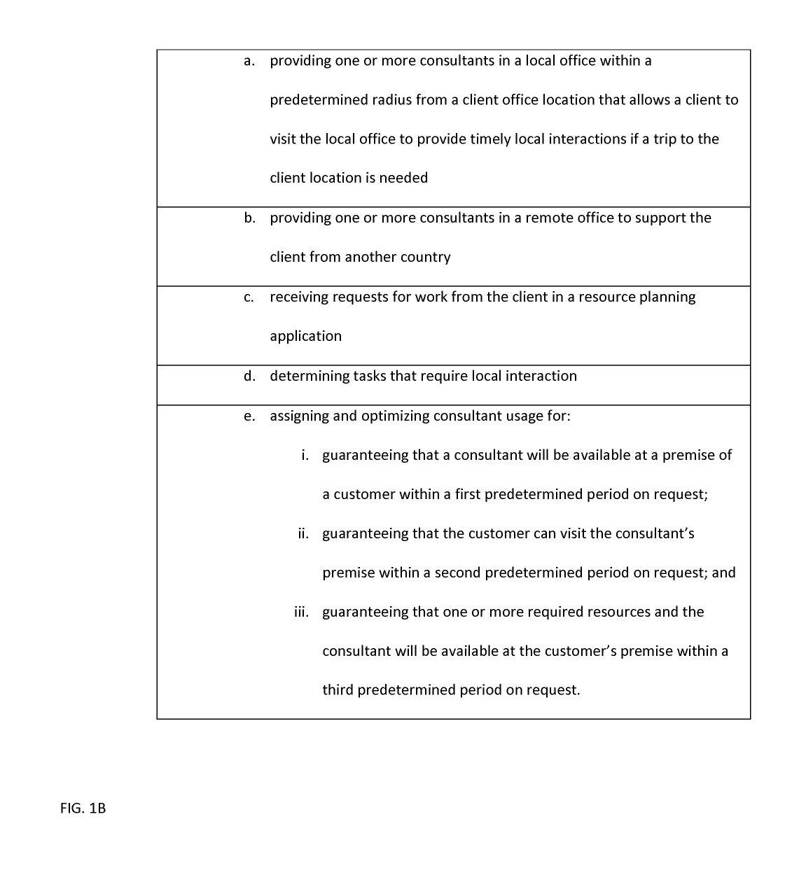

Referring to FIG. 1A, a computer system 100 includes a processor 110 and memory 120 coupled to a computer bus 130 or other suitable interconnect. The memory 120 has a resource planning application 122 and a resource database 124 stored thereon. The resource planning application 122 is capable of receiving (e.g., includes executable instructions for receiving) information from the resource database 124 and capable of transmitting (e.g., includes executable instructions for transmitting) new information to the resource database 124. For example, the resource database 124 may include information on certain workers in a business and the time availability of those workers. In such a case, the resource planning application 122 is capable of receiving worker availability information from the resource database 124 so as to schedule a new assignment for that worker in a time slot of an electronic schedule. When the new assignment is scheduled, the worker's availability information in the resource database 124 is modified accordingly. In some implementations, a computer program product installed onto the memory 120 may include the resource planning application 122, of which the electronic schedule is a sub-application. Alternatively, the electronic schedule may be a separate application stored on the memory 120. In the examples below, the scheduling of a resource is what determines the use of that resource. Alternatively, scheduling may be used to estimate the utilization of the resource; that is, to determine the workload of the resource although the scheduling does not actually govern the use of the resource. Thus, the systems and techniques described herein may be used for directly managing a resource's workload or for determining the resource's workload.

FIG. 1B shows an exemplary method for scheduling local and remote resources to provide high-touch outsourcing that interfaces with the client locally for face to face discussion, yet minimizing total cost. The method includes:
a. providing one or more consultants in a local office within a predetermined radius from a client office location that allows a client to visit the local office to provide timely local interactions if a trip to the client location is needed;
b. providing one or more consultants in a remote office to support the client from another country;
c. receiving requests for work from the client in a resource planning application;
d. determining tasks that require local interaction and selecting one or more consultants from the local office and otherwise assigning tasks to consultants in another country to reduce cost;
e. assigning and optimizing consultants in the resource planning application for:
   i. guaranteeing that a consultant will be available at the local office within a first predetermined period on request;
   ii. guaranteeing that the customer can visit the local office within a second predetermined period on request; and
   iii. guaranteeing that one or more consultants will be available at the customer's premise within a third predetermined period on request.

The resource planning application 122 is capable of receiving requests for a resource's time and it knows the location of each consultant to optimize consultant cost and to ensure that the consultant can be at the client's premise as required under the Service Level Agreement with the client. For example, a consulting firm may use the resource planning application 122 to manage the schedules of consultants (resources). In such a situation, a client or a scheduling manager may request that a particular consultant—any consultant having particular qualifications—work on project for a certain number of hours on-site, yet the total cost of the project has to be less than the cost of hiring all local consultants. The resource planning application 122 may receive non-concrete requests that include a date range and the estimated amount of time needed from the resource, but does not include concrete date and time facts. For example, the non-concrete request may ask for support for forty hours (i.e., the estimated amount of time) on a project at any time in the month of January (i.e., date range of January 1-31). This non-concrete request may be later refined by a subsequent concrete request, which specifies concrete date and time the consultant has to be at the client's office or premise to reserve at least a portion of the resource's time that was originally requested by the non-concrete request. Continuing with the previous example, the concrete request may ask for the consultant to work on a particular aspect of the project for eight hours on January 15 during the time slot of 8:00 AM to 4:00 PM, thus permitting the remaining thirty-two hours from the original request to be served on other days in January. By permitting the resource's time to be initially reserved with a non-concrete request and then later refined with a concrete request for local support, the resource's time may be scheduled in an efficient manner while minimizing over cost.

Still referring to FIG. 1, the processor 110 and memory 120 are interconnected to at least one I/O (input/output) device 140 in the computer system 100. The I/O device 140 can be connected with one or more user interface devices 150, such as a keyboard, mouse, display, or the like. The user interface devices 150 permit a user of the computer system 100 to interact with various components of the computer system 100 or permit a user to cause certain processes to be executed. The I/O device 140 may be connected to a network 160, such as the Internet or a local area network. The connection with the network 160 permits the computer system 100 to communicate with one or more remote computer systems 170. For example, a remote computer system 170 may include a resource planning application 172 similar to the previously described application 122. In such an implementation, the resource planning application 172 of the remote computer system 170 may receive information from the resource database 124 via the network connection. Thus, the resource planning application 172 may be capable of receiving information from the resource database 124 and capable of transmitting new information to the resource database 124.

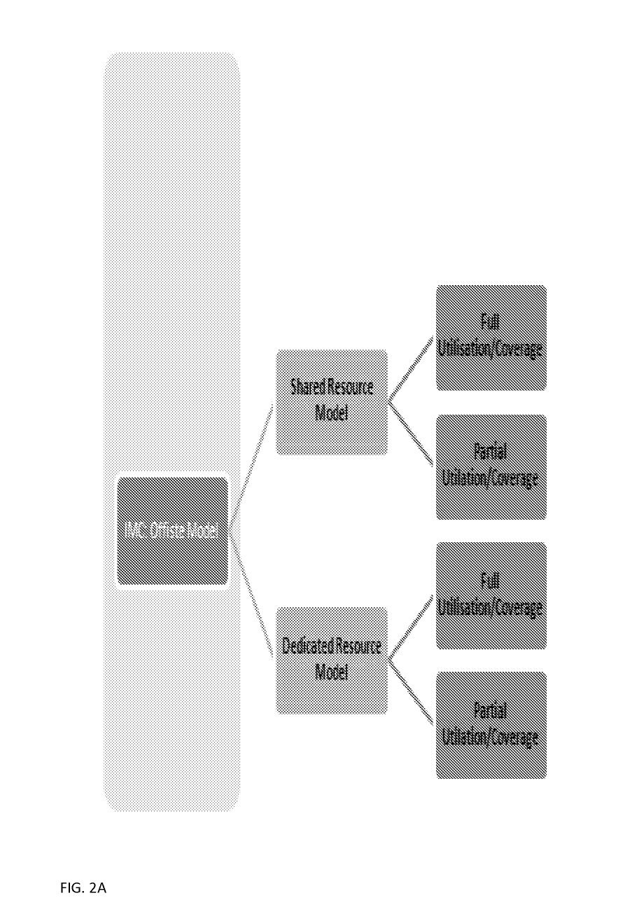

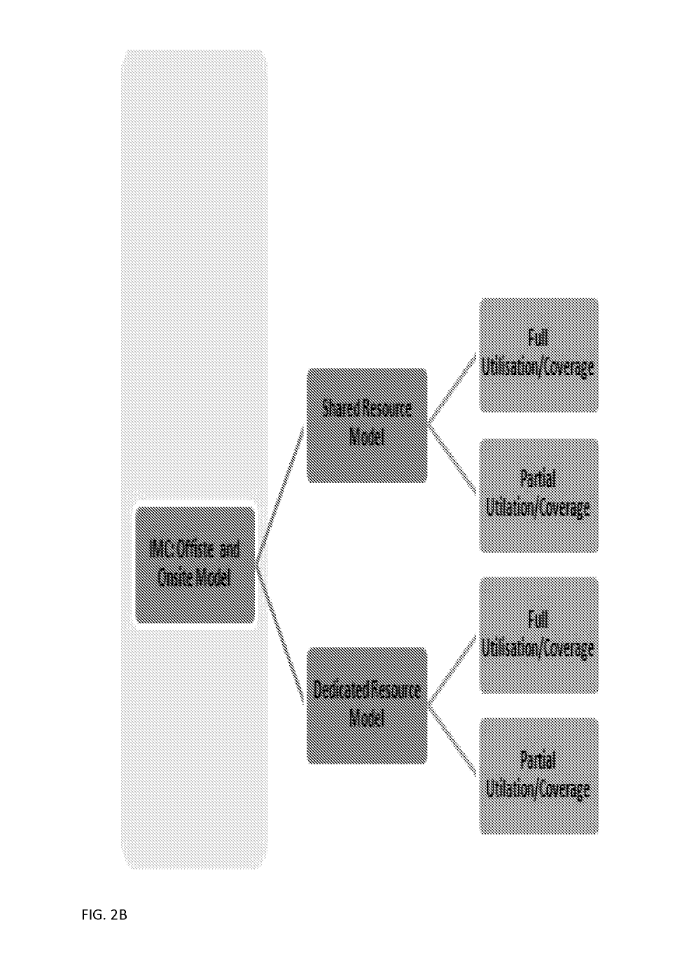

FIGS. 2A-2B show two exemplary embodiments in accordance with aspects of the present system. FIG. 2A shows an exemplary off-site model, while FIG. 2B shows an exemplary on-site and off-site model. Either embodiment uses a shared resource model and a dedicated resource model. The shared resource model or the dedicated resource model enables the client or customer to have full or partial utilization of the consultant as needed.

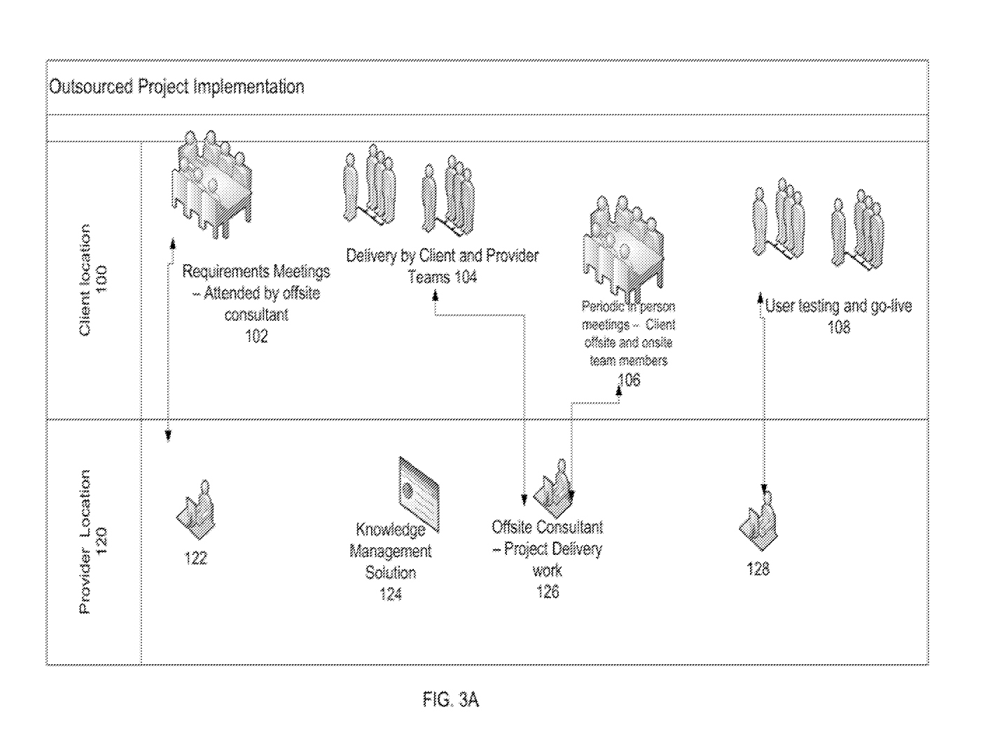

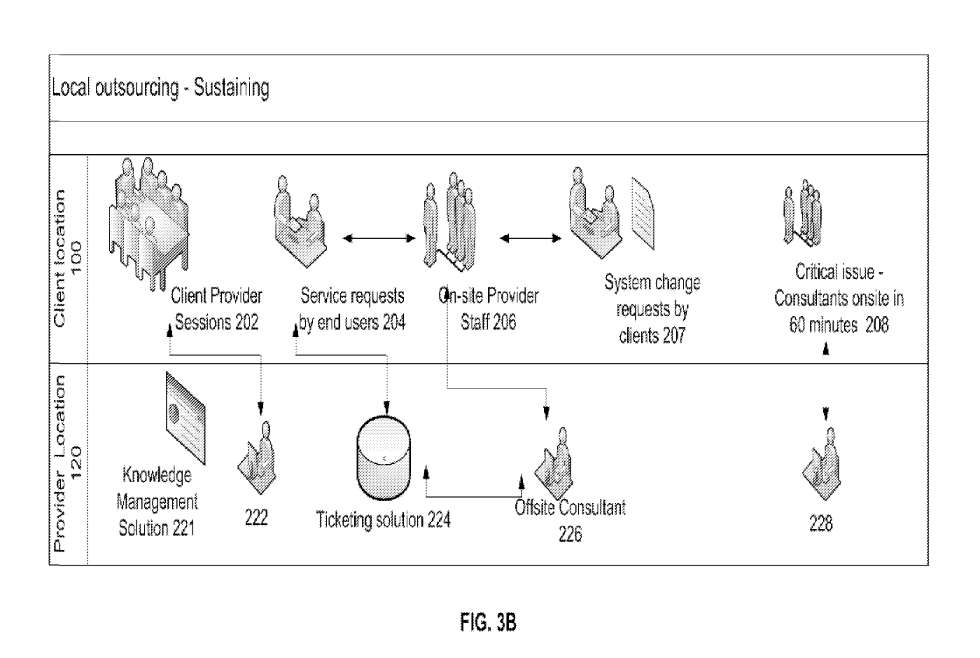

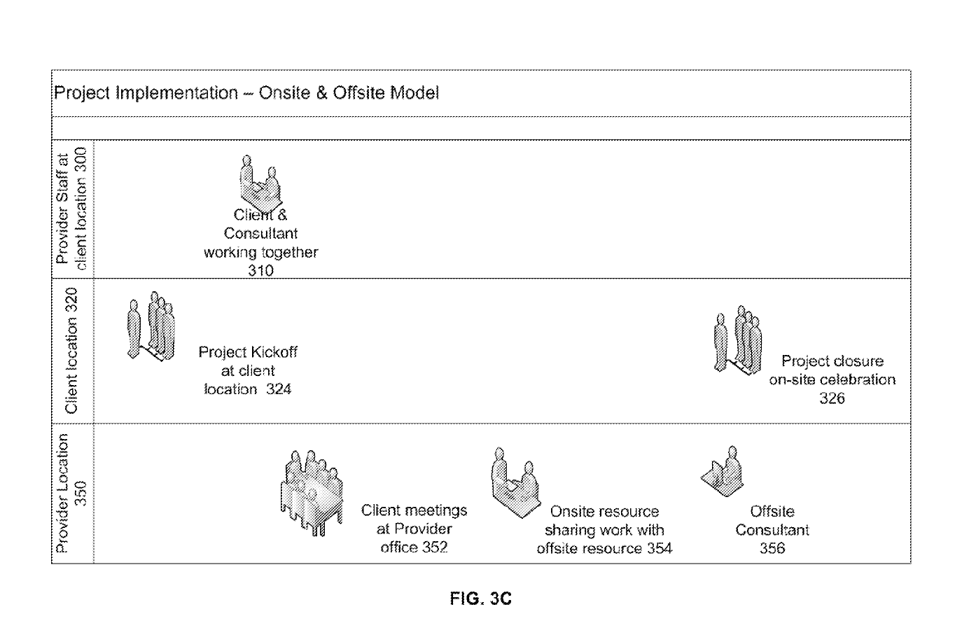

FIGS. 3A-3B show exemplary local outsourcing systems. The systems of FIG. 3A-3C provides local outsourcing by:
a. guaranteeing that a consultant will be available at a premise of a customer within a first predetermined period on request;
b. guaranteeing that the customer can visit the consultant's premise within a second predetermined period on request; and
c. guaranteeing that one or more required resources and the consultant will be available at the customer's premise within a third predetermined period on request.

In FIG. 3A, a locally outsourced project implementation is shown. The implementers collaborate at a client location 100 and a provider location 120. The provider can be a suitable IT consulting company with offices within a predetermined radius from the client office location 100 to provide timely local interactions if a trip to the client location 100 is needed. In FIG. 3A, the project can be kicked off with a requirements meeting that is attended by the provider's consultants 102. The consultants 102 can do the work afterward at the provider location 120, or can communicate and hand-off the work to other consultants 122 at the provider location 120. The consultant 122 can access solutions 124 or other resources such as experts at the provider location 120. One or more off site consultants 126 work on the requirements, and eventually delivers work product at various milestones. The work product is delivered to the client by the provider team 104, and one or more periodic in person meetings can be conducted at the client, off-site and on-site with team members 106. The completed project can undergo user testing and go-live at 108, and additional consultants 128 specializing in testing at the provider location 120 can assist if needed.

Turning now to FIG. 3B, a local outsourcing system for sustaining work is shown. In this system, a client provider session is conducted in 202, and the result can be communicated to an off site consultant 222 who has access to various knowledge management solutions 221 at the provider location 120.

During operation, one or more service requests can be made by the client in 204, and the requests can be captured in a ticketing system 224, which in turn sends the request to other offsite consultants in 226. The offsite consultants work in parallel with and communicate the solutions to the provider's on-site staff in 206. The result can be converted into system change requests by clients at the site 100 in 207. Additionally, one or more off site consultants 228 can address critical issues raised by the client in 208. If needed, the offsite consultants can travel to the client location 100 within a predetermined time, such as 60 minutes, for example.

FIG. 3C shows an exemplary on-site and off-site system to work on a project. In this system, staff personnel from a provider works at a separate location 300, a client location 320, or a provider location 350. The project can be kicked off at the client location in 324. The client and provider consultants can work together at 310. Additionally, client meetings can occur at the provider office in 352, and on-site resources can share work with off-site resources in 354 and 356. The project begins and ends at the client location 320, and project closure is celebrated in 326.

In one exemplary system to provide local outsourcing services, a customer can select a provider company (such as DGN Technologies of Fremont, Calif.). The provider company in turn employs one or more consultants. The customer can have implementation outsourcing work or sustaining work to be performed by the provider company. The sustaining work is typically for maintenance of existing system which is running but may need periodic support such as system management during outages. Such work is unpredictable but requires the client to staff for the worst case during system downtime. However, such staff is mostly idled since system downtime is the exception rather than the rule. Typically, the provider company has offices that are within a predetermined range of the client's offices so that the consultant can be available at the client's office relatively quickly.

In the context of the preferred embodiment, the term “consultant” or “provider” should not limit the size of the entity providing outsourced services within a predetermined region of the customer or client. The consultant or provider may constitute a private individual, a multi-national corporation, or any sized entity in between that provides outsourcing services within a predetermined region of the customer or client.

In addition, some implementations have been described to include a professional consultant or a service technician as the “resource” that has available time. The system is not limited to such implementations. For example, the resource may be a machine, a person such as a worker, a tool, a workstation, or any other resource that may be fully utilized by efficient scheduling.

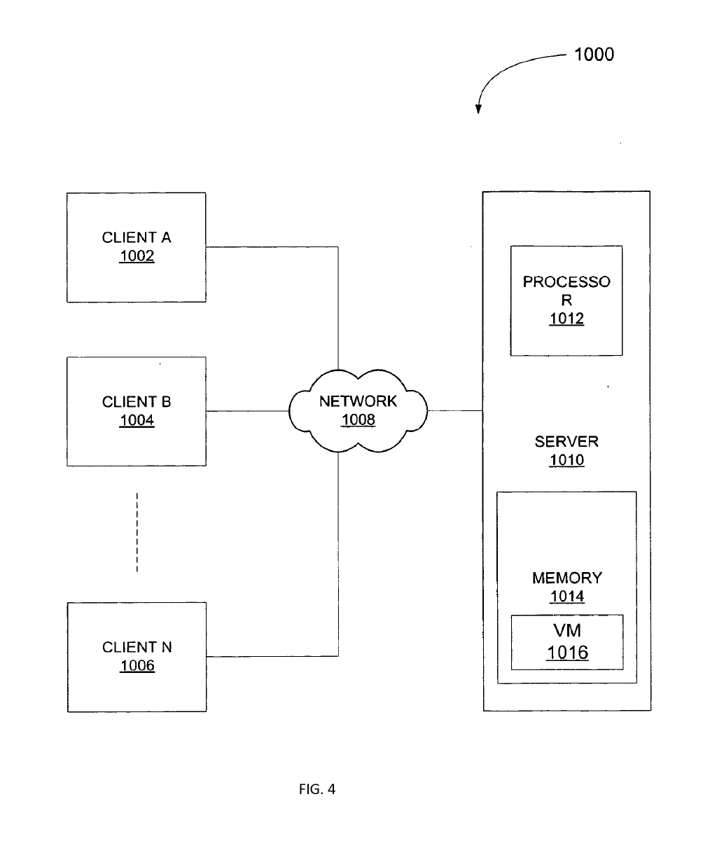

FIG. 4 illustrates an exemplary client/server system 1000 used in implementing one or more embodiments of the invention. In the illustrated embodiment, a network 1008 links a server 1010 with various client systems A-N 1002-1006. The server 1010 is a programmable data processing system suitable for implementing apparatus, programs, or methods in accordance with the description. The server 1010 provides a core operating environment for one or more runtime systems that process user requests. The server 1010 includes a processor 1012 and a memory 1014. The memory 1014 can be used to store an operating system a Transmission Control Protocol/Internet Protocol (TCP/IP) stack for communicating over the network 1008, and machine-executable instructions executed by the processor 1012. In some implementations, the server 1010 can include multiple processors, each of which can be used to execute machine-executable instructions. The memory 1014 can include a shared memory area that is accessible by multiple operating system processes executing at the server 1010. An example of a suitable server to be implemented using the client/server system 1000 may include J2EE compatible servers, such as the Web Application Server developed by SAP AG of Walldorf, Germany, or the WebSphere Application Server developed by International Business Machines Corp. of Armonk, N.Y. Client systems 1002-1006 are used to execute multiple applications or application interfaces. Each instance of an application or an application interface can constitute a user session. Each user session can generate one or more requests to be processed by the server 1010. The requests may include instructions or code to be executed on a runtime system (e.g., the virtual machine (VM) 1016) on the server 1010. A VM 1016 is an abstract machine that can include an instruction set, a set of registers, a stack, a heap, and a method area, like a real machine or processor. A VM 1016 essentially acts as an interface between program code and the actual processor or hardware platform on which the program code is to be executed. The program code includes instructions from the VM instruction set that manipulates the resources of the VM 1016.

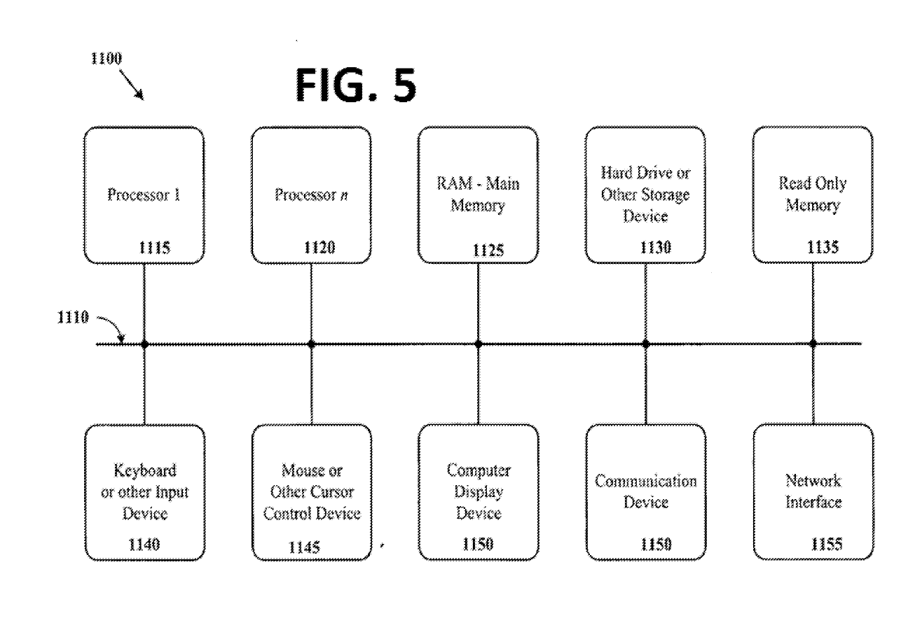

FIG. 5 is an exemplary computer system 1100 used in implementing an embodiment of the present invention. In this illustration, a system 1100 comprises a bus 1110 or other means for communicating data. The system 1100 includes one or more processors, illustrated as shown as processor 1 1115 through processor n 1120 to process information. The system 1100 further comprises a random access memory (RAM) or other dynamic storage as a main memory 1125 to store information and instructions to be executed by the processor 1115 through 1120. The RAM or other main memory 1125 also may be used for storing temporary variables or other intermediate information during execution of instructions by the processors 1115 through 1120. A hard drive or other storage device 1130 may be used by the system 1100 for storing information and instructions. The storage device 1130 may include a magnetic disk or optical disc and its corresponding drive, flash memory or other nonvolatile memory, or other memory device. Such elements may be combined together or may be separate components. The system 1100 may include a read only memory (ROM) 1135 or other static storage device for storing static information and instructions for the processors 1115 through 1120. A keyboard or other input device 1140 may be coupled to the bus 1110 for communicating information or command selections to the processors 1115 through 1120. The input device 1140 may include a keyboard, a keypad, a touch-screen and stylus, a voice-activated system, or other input device, or combinations of such devices. The computer may further include a mouse or other cursor control device 1145, which may be a mouse, a trackball, or cursor direction keys to communicate direction information and command selections to the processors and to control cursor movement on a display device. The system 1100 may include a computer display device 1150, such as a cathode ray tube (CRT), liquid crystal display (LCD), or other display technology, to display information to a user. In some environments, the display device may be a touch-screen that is also utilized as at least a part of an input device. In some environments, the computer display device 1150 may be or may include an auditory device, such as a speaker for providing auditory information. A communication device 1150 may also be coupled to the bus 1110. The communication device 1150 may include a modem, a transceiver, a wireless modem, or other interface device. The system 1100 may be linked to a network or to other device using via an interface 1155, which may include links to the Internet, a local area network, or another environment. The system 1100 may comprise a server that connects to multiple devices. In one embodiment the system 1100 comprises a Java™ compatible server that is connected to user devices and to external resources.

While the machine-readable medium 1130 is illustrated in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine of the system 1100 and that causes the machine to perform any one or more of the methodologies of the present invention. The term “machine-readable medium” shall accordingly be taken to include, but not be limited to, solid-state memories, optical and magnetic media, and carrier wave signals.

An article of manufacture may be used to store program code. An article of manufacture that stores program code may be embodied as, but is not limited to, one or more memories (e.g., one or more flash memories, random access memories (static, dynamic or other)), optical disks, CD-ROMs, DVD-ROMs, EPROMs, EEPROMs, magnetic or optical cards or other type of machine-readable media suitable for storing electronic instructions. Program code may also be downloaded from a remote computer (e.g., a server) to a requesting computer (e.g., a client) by way of data signals embodied in a propagation medium (e.g., via a communication link (e.g., a network connection)).

Furthermore, it is appreciated that a lesser or more equipped computer system than the example described above may be desirable for certain implementations. Therefore, the configuration of system 1100 may vary from implementation to implementation depending upon numerous factors, such as price constraints, performance requirements, technological improvements, and/or other circumstances.

It is noted that processes taught by the discussion above can be practiced within various software environments such as, for example, object-oriented and non-object-oriented programming environments, Java based environments, such as a J2EE environment or environments defined by other releases of the Java standard), or other environments (e.g., a NET environment, a Windows/NT environment each provided by Microsoft Corporation).

It should be noted that, while the embodiments described herein may be performed under the control of a programmed processor, such as processors 1115 through 1120, in alternative embodiments, the embodiments may be fully or partially implemented by any programmable or hardcoded logic, such as field programmable gate arrays (FPGAs), TTL logic, or application specific integrated circuits (ASICs). Additionally, the embodiments of the present invention may be performed by any combination of programmed general-purpose computer components and/or custom hardware components. Therefore, nothing disclosed herein should be construed as limiting the various embodiments of the present invention to a particular embodiment wherein the recited embodiments may be performed by a specific combination of hardware components.

It should be appreciated that reference throughout this specification to “one embodiment” or “an embodiment” means that a particular feature, structure or characteristic described in connection with the embodiment is included in at least one embodiment of the present invention. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the invention.

Similarly, it should be appreciated that in the foregoing description of exemplary embodiments of the invention, various features of the invention are sometimes grouped together in a single embodiment, figure, or description thereof for the purpose of streamlining the disclosure aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the detailed description are hereby expressly incorporated into this detailed description, with each claim standing on its own as a separate embodiment of this invention.

While certain exemplary embodiments have been described and shown in the accompanying drawings, it is to be understood that such embodiments are merely illustrative of and not restrictive, and that the embodiments of the present invention are not to be limited to specific constructions and arrangements shown and described, since various other modifications may occur to those ordinarily skilled in the art upon studying this disclosure.

What is claimed is:

1. A method for scheduling local and remote resources to provide local outsourcing, comprising:
a. providing one or more consultants in a local office within a predetermined radius from a client office location that allows a client to visit the local office to provide timely local interactions if a trip to the client location is needed;
b. providing one or more consultants in a remote office to support the client from another country;
c. receiving requests for work from the client in a resource planning application;
d. determining tasks that require local interaction and selecting one or more consultants from the local office and otherwise assigning tasks to consultants in another country to reduce cost;
e. assigning and optimizing consultants in the resource planning application for:
i. guaranteeing that a consultant will be available at the local office within a first predetermined period on request;
ii. guaranteeing that the customer can visit the local office within a second predetermined period on request; and
iii. guaranteeing that one or more consultants will be available at the customer's premise within a third predetermined period on request.

2. The method of claim 1, comprising paying the consultant a reduced rate over an extended period in exchange for brief periods of maintenance work.

3. The method of claim 2, wherein the extended period comprises a month and the brief period comprises a few days of maintenance work.

4. The method of claim 1, wherein a provider has offices within a predetermined radius.

5. The method of claim 1, comprising starting a project with a requirements meeting attended by the provider's consultants at the client office.

6. The method of claim 1, wherein the provider's consultants work at the provider location, or hand-off the work to other consultants at the provider location.

7. The method of claim 1, comprising accessing knowledge management solutions or other resources at the provider location.

8. The method of claim 1, comprising delivering work product done at the provider location to the client.

9. The method of claim 1, comprising conducting one or more periodic in person meetings at the client, off-site and on-site with team members.

10. The method of claim 1, comprising performing testing and go-live services by additional consultants specializing in testing at the provider location.

11. A system to provide local outsourcing, comprising:
a. means for guaranteeing a consultant will be available at a premise of a customer within a first predetermined period on request;
b. means for guaranteeing that the customer can visit the consultant's premise within a second predetermined period on request; and
c. means for guaranteeing that one or more required resources and the consultant will be available at the customer's premise within a third predetermined period on request.

12. The system of claim 11, comprising means for paying the consultant a reduced rate over an extended period in exchange for brief periods of maintenance work.

13. The system of claim 12, wherein the extended period comprises a month and the brief period comprises a few days of maintenance work.

14. The system of claim 11, wherein a provider has offices within a predetermined radius from a client office location to provide timely local interactions if a trip to the client location is needed.

15. The system of claim 11, comprising means for starting a project with a requirements meeting attended by the provider's consultants at the client office.

16. The system of claim 11, wherein the provider's consultants work at the provider location, or hand-off the work to other consultants at the provider location.

17. The system of claim 11, comprising means for accessing knowledge management solutions or other resources at the provider location.

18. The system of claim 11, comprising means for delivering work product done at the provider location to the client.

19. The system of claim 11, comprising means for conducting one or more periodic in person meetings at the client, off-site and on-site with team members.

20. The system of claim 11, comprising means for performing testing and go-live services by additional consultants specializing in testing at the provider location.
